(19) United States
(12) Patent Application Publication
(10) Pub. No.: US 2014/0083566 A1
(43) Pub. Date: Mar. 27, 2014

(54) REMOVABLE BRAKE FOR DEBARKER ARM

(71) Applicants: Marc Lepage, Mont-St-Hilaire (CA); David Marion, Mont-St-Hilaire (CA)

(72) Inventors: Marc Lepage, Mont-St-Hilaire (CA); David Marion, Mont-St-Hilaire (CA)

(73) Assignee: Équipement Boifor inc., McMasterville (CA)

(21) Appl. No.: 13/629,052

(22) Filed: Sep. 27, 2012

(30) Foreign Application Priority Data
Sep. 27, 2012 (CA) 2791437

(51) Int. Cl. B27L 1/00

(52) U.S. Cl. 144/208.1

(57) ABSTRACT

The present document describes a removable brake for a debarker arm having a working end with a debarking tool configured to remove bark from a log, the removable brake comprising a main body; a mounting surface for removably mounting the main body on the debarker arm; a leading edge on one end of the main body for causing the debarker arm to move from an inner position toward an outer position when the leading edge of the main body engages an end face of the log moving along a processing line toward the leading edge; and a brake portion on another end of the main body for increasing the resistance offered against the debarker arm while debarking the log.

### CROSS-REFERENCE TO RELATED APPLICATIONS

This application claims priority from Canadian patent application number not yet available, filed on Sep. 27, 2012.

### BACKGROUND

(a) Field

The subject matter disclosed generally relates to debarker arms. More particularly, the subject matter disclosed relates to debarker arms with removable brake.

(b) Related Prior Art

Rotary log debarkers are used to remove bark from logs to facilitate processing of the logs into lumber and other wood products. Rotary log debarkers often have an array of debarker arms pivotally mounted to a rotatable ring. Each of the debarker arms has a tip or a debarking tool for scraping bark from the logs.

As a log moves along a processing line of a debarker, the advancing log contacts and pushes against the leading edges of the debarker arms carried by the rotatable ring. The log then drives the debarker arms outwardly until the tips of the debarker arms engage the periphery of the log. In this sense, debarker arms can be self-opened. Once opened, the debarker arms are urged inwardly such that the tips scrape/cut bark off the log. The tips remove the bark in somewhat spiral pattern as the log travel through the debarker.

Unfortunately, the leading edges of the debarker arms, but also the debarker arms themselves and the cutting tips, may be damaged due to the applied loads (e.g., the axial loads produced when each of the logs strikes against the debarker arms) and frictional interaction with the logs. After repeated use, the leading edges of the debarker arms, the debarker arms themselves and the cutting tips, may become dull, blunt, roughened, or otherwise damaged such that undesirable large frictional forces are present when the leading edges contact the logs. These frictional forces can prevent proper self-opening of the debarker arm and may also damage the ends of the logs. For example, roughened leading edges can scrape wood from the periphery of the logs, thus reducing the amount of usable wood resulting in decreased lumber production.

Canadian patent no. 2,131,066 describes a debarker arm for debarking machine including a crescent shaped member, a debarker arm support, an outwardly forwardly extending flange and a debarker tip receptacle and where the outwardly forwardly extending flange extends above and forwardly the debarker tip receptacle in the direction of incoming logs. This configuration allows leading edges to be partially or totally protected. However, the same configuration does not allow the debarker arm itself to be protected against damaged due to the applied loads and results in frequently replacing the debarker arms with new debarker arms, resulting in time and money loss.

To maintain proper self-opening and limit this unwanted damage to the logs, the leading edges of the debarker arms and the debarker arms themselves, are often repaired by building-up new leading edges. For example, material can be welded over a damaged leading edge to form a new leading edge or material can be welded over a damaged debarker arm to form a new debarker arm. Unfortunately, because welding often creates irregular surfaces, it may be difficult to form a leading edge sufficiently smooth for consistent self-opening of the debarker arm. Moreover, a lengthy welding process can result in significant machine downtime, thereby reducing lumber production. Other problems, such as induced residual stresses, reduced toughness, and the like are also associated with welding processes.

Because leading edges of debarker arms and debarker arms are difficult to repair, debarker arms may be frequently replaced with new debarker arms, resulting in time and money loss.

There is therefore a need for an improved removable brake for debarker arms.

### SUMMARY

According to an embodiment, there is provided a removable brake for a debarker arm having a working end to which is removably installed a debarking tool configured to remove bark from a log, the removable brake comprising: a main body; a mounting surface on the main body for removably mounting the removable brake near the working end of the debarker arm; and a brake portion on the main body for increasing a resistance offered against the debarker arm while debarking the log.

According to another embodiment, the mounting surface further includes a mating connector for removably engaging with a corresponding mating connector of the debarker arm.

According to another embodiment, the mating connector and the corresponding connector form a dovetail sliding arrangement.

According to another embodiment, the removable brake further comprises a fastener for removably mounting the removable brake to the debarker arm.

According to another embodiment, the main body comprises an opening for receiving the fastener.

According to another embodiment, the fastener comprises a plurality of fasteners for removably mounting the removable brake to the debarker arm.

According to another embodiment, the main body comprises a plurality of openings for correspondingly receiving the plurality of fasteners.

According to another embodiment, the removable brake further comprises a leading edge extending from the main body for causing the debarker arm to move from an inner position toward an outer position when the leading edge of the main body engages an end face of the log moving along a processing line toward the leading edge.

According to another embodiment, the leading edge of the main body corresponds to a shape defined by an edge of the debarker arm.

According to another embodiment, the brake portion is lower than leading edge thereby forming a step between the brake portion and the leading edge.

According to another embodiment, the removable brake is integrally formed.

According to another embodiment, there is provided a debarker arm apparatus comprising: a debarker arm having a working end to which is removably installed a debarking tool configured to remove bark from a log; a removable brake removably mounted to the debarker arm, the removable brake comprising: a main body; a mounting surface on the main body for removably mounting the removable brake near the working end of the debarker arm; and a brake portion on the main body for increasing a resistance offered against the debarker arm while debarking the log.

According to another embodiment, the debarker arm apparatus further comprises a plurality of fasteners removably mounting the main body to the debarker arm.

According to another embodiment, the main body comprises a plurality of openings receiving the corresponding plurality of fasteners.

According to another embodiment, the main body further includes a mating connector for removably engaging with a corresponding mating connector of the debarker arm.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a perspective view of a removable brake for a debarker arm, where the removable brake is shown removably mounted on the debarker arm in accordance with an embodiment;

FIG. 2 is rear elevation view of the removable brake of FIG. 1, showing the mounting surface for removably mounting the removable brake on the debarker arm;

FIG. 3 is a front elevation view of the removable brake of FIG. 1, showing the surface opposite to the mounting surface;

FIG. 4 is another front elevation view of the removable brake for a debarker arm of FIG. 1 mounted on the debarker arm;

FIG. 5 is a perspective view of the removable brake installed on the debarker arm of FIG. 1, showing a working end of the debarker arm without its debarking tool configured to remove bark from a log;

FIG. 6 is a perspective view of the debarker arm of FIG. 1, showing its debarker arm receiving recess;

FIG. 7 is a perspective view of a debarker arm in accordance with another embodiment, showing its debarker arm receiving recess;

FIG. 8 is a front perspective view of the removable brake for removable mounting on the debarker arm of FIG. 7 showing the surface opposite to the mounting surface;

FIG. 9 is a rear perspective view of the removable brake for removable mounting on the debarker arm of FIG. 7, showing the mounting surface for removably mounting the removable brake on the debarker arm;

FIG. 10 is a perspective view of the removable brake for removable mounting on the debarker arm of FIG. 7 for a debarker arm, where the removable brake is shown removably mounted on the debarker arm;

FIG. 11 is a perspective view of a removable brake for a debarker arm in accordance with another embodiment, where the removable brake is shown removably mounted on the debarker arm;

FIG. 12 is a side elevation view of the debarker arm of FIG. 11, showing its debarker arm receiving recess; and

FIG. 13 is a rear elevation view of the removable brake of FIG. 11, showing the mounting surface for removably mounting the removable brake on the debarker arm.

It will be noted that throughout the appended drawings, like features are identified by like reference numerals.

### DETAILED DESCRIPTION

In embodiments there are disclosed a removable brake for a debarker arm, a debarker arm apparatus and a method for debarking a log using a debarker arm apparatus and its removable brake.

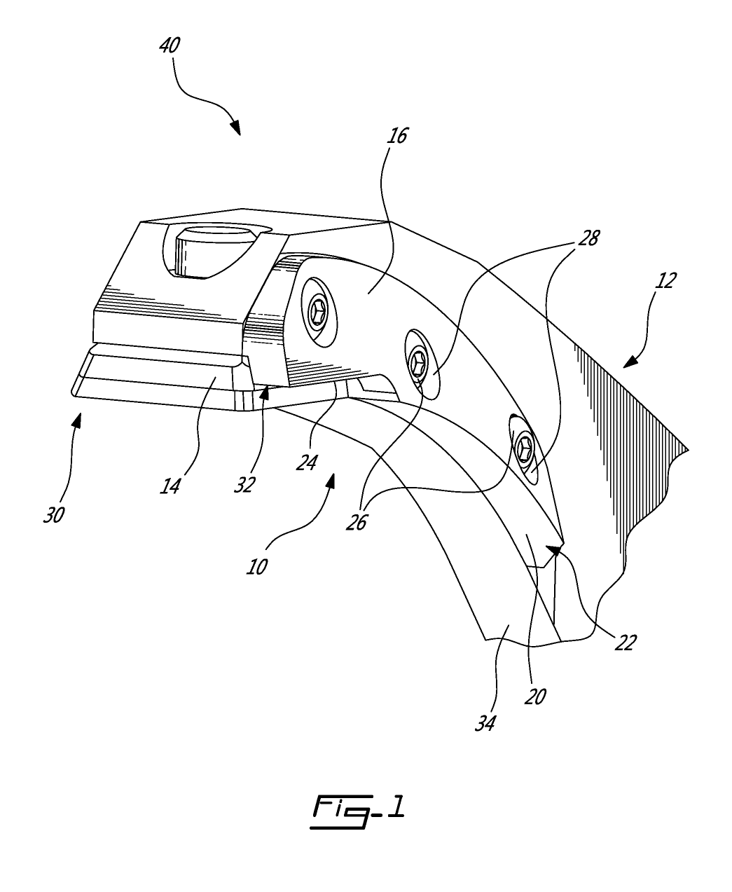

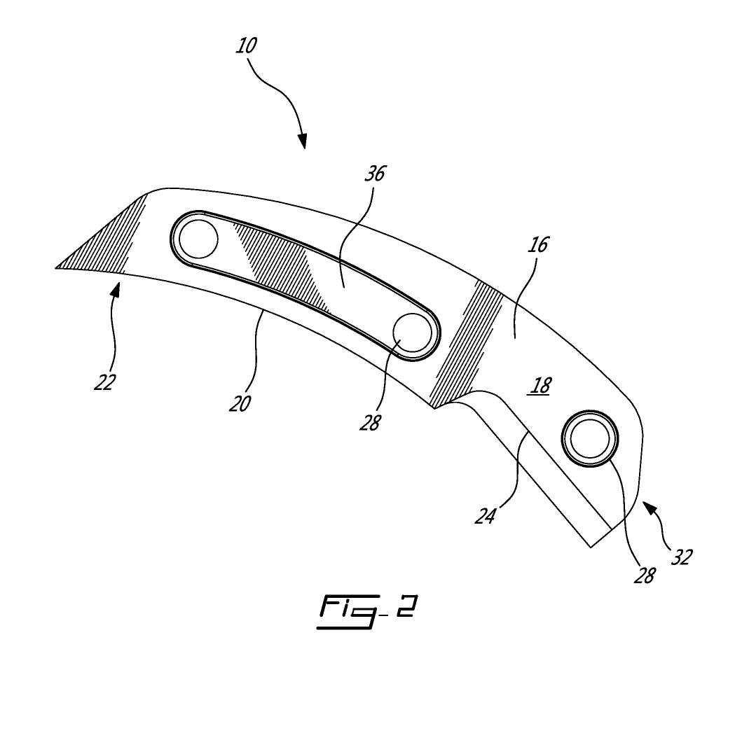

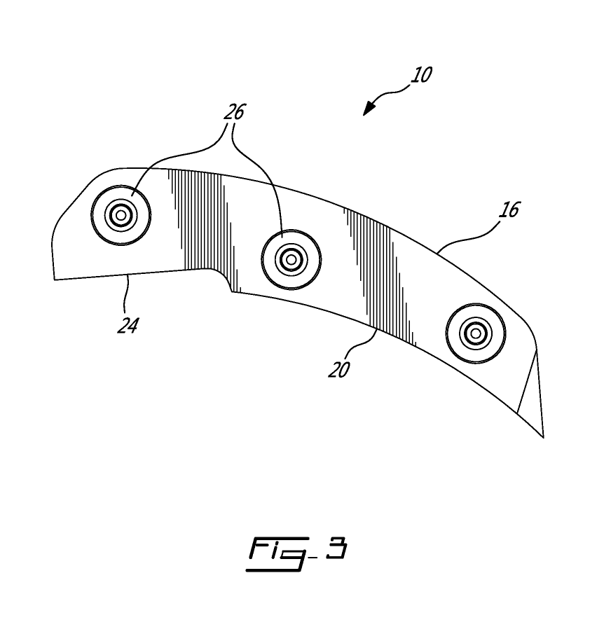

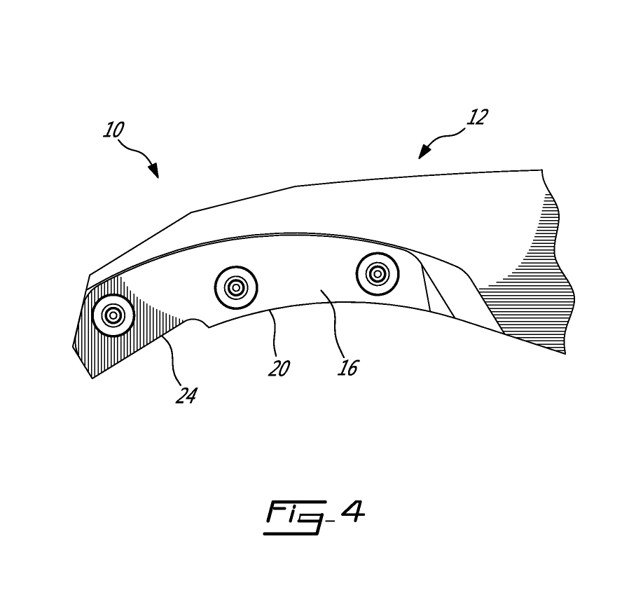

Referring now to the drawings, and more particularly to FIGS. 1, 2, 3 and 4, there is shown a removable brake 10 for a debarker arm 12. FIG. 1 shows that the debarker arm 12 has a working end 30 to which is removably installed a debarking tool 14 (also referred to as a cutting die or cutting tip) configured to remove bark from a log(not shown). The removable brake 10 includes a main body 16 and a mounting surface 18 (FIG. 2), where the mounting surface 18 is for removably mounting the removable brake 10 on the debarker arm 12. The removable brake 10 also includes a leading edge 20 starting at one end 22 of the main body 16 for causing the debarker arm 12 to move from an inner position toward an outer position when the leading edge 20 of the main body 16 engages an end face of the log(not shown) moving along a processing line toward the leading edge 20. The removable brake 10 also includes a brake portion 24 starting at another end 32 of the main body 16 for increasing the resistance offered against the debarker arm 12 while debarking the log.

According to an embodiment, the leading edge 20 of the main body 16 may correspond to a shape defined by an edge 34 of the debarker arm 12. According to an embodiment, the brake portion 24 forms a step/depression relative to the leading edge 20 and is thereby “lower” relative to leading edge 20.

According to another embodiment and still referring to FIGS. 1, 2, 3 and 4, the removable brake 10 may further include a fastener 26 for removably mounting the main body 16 to the debarker arm 12. The fastener 26 may also include a plurality of fasteners 26 for removably mounting the main body 16 on the debarker arm 12. As shown on FIGS. 1 to 3, the main body 16 of the removable brake 10 includes three fasteners 26 for removably mounting the main body 16 on the debarker arm 12. The main body 16 also includes an opening 28 for receiving the fastener 26. The main body 16 may also include a plurality of openings 28 for receiving the corresponding plurality of fasteners 26. As shown on FIGS. 1 to 3, the main body 16 of the removable brake 10 includes three openings 28 for receiving the corresponding three fasteners 26.

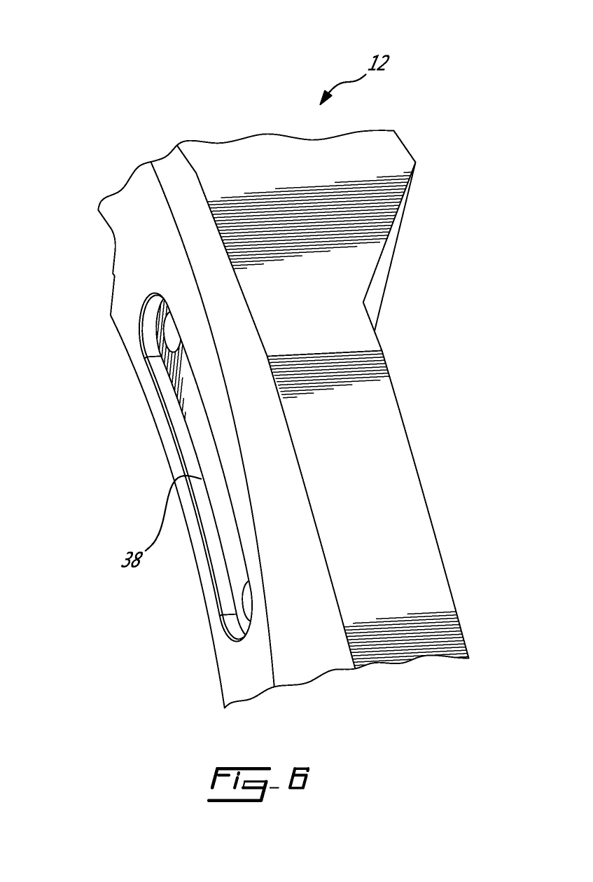

According to another embodiment, the main body 16 may further include a mating connector 36 for removably engaging with a corresponding mating connector 38 (see FIG. 6) of the debarker arm 12. In the example shown in FIGS. 2 and 6, the mating connector 36 is a protruding portion while the corresponding mating connector 38 is a recess portion. According to another embodiment, the mating connector 36 and the corresponding mating connector 38 can be a sliding dovetail arrangement (such that the need for fasteners 26 is eliminated) and/or any other suitable connector arrangement for removably engaging the removable brake 10 to the debarker arm 12.

According to another embodiment and still referring to FIGS. 1 to 3, there is shown a debarker arm apparatus 40. The debarker arm apparatus 40 includes a debarker arm 12 which has a working end 30 to which is removably installed a debarking tool 14 and configured to remove bark from a log. The debarker arm apparatus 40 also includes a removable brake 10 removably mounted to the debarker arm 12. As described above, the removable brake 10 removably mounted on the debarker arm 12 includes a main body 16 and a mounting surface 18 on the main body 16 for removably mounting the removable brake 10 near the working end 30 of the debarker arm 12. The removable brake 10 also includes a leading edge 20 on one end 22 of the main body 16 for causing the debarker arm 12 to move from an inner position toward an outer position when the leading edge 20 of the main body 16 engages an end face of the log(not shown) moving along a processing line toward the leading edge 20. The debarker arm apparatus 40 further includes a brake portion 24 on starting at another end 32 of the main body 16 for increasing the resistance offered against the debarker arm 12 while debarking the log.

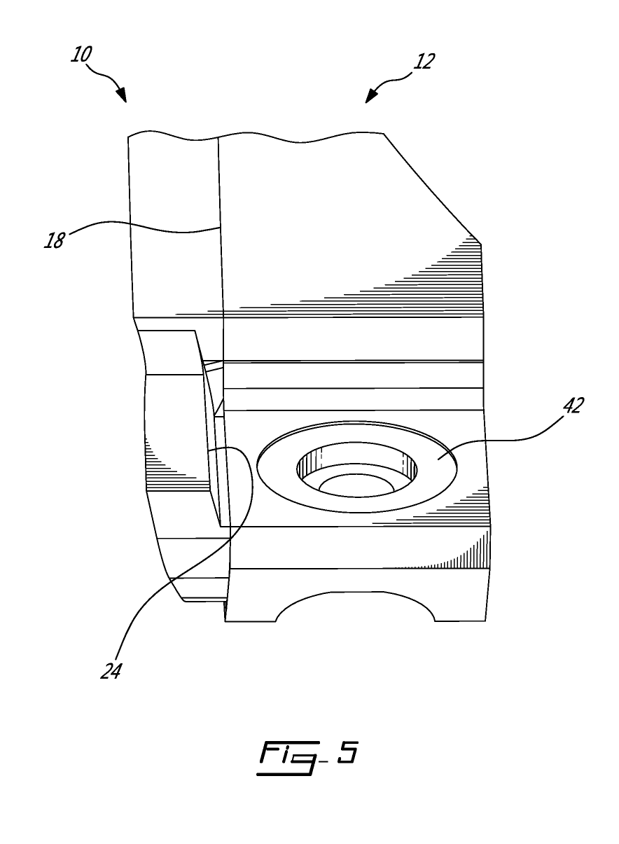

According to another embodiment and referring now to FIG. 5, there is shown a perspective view of the removable brake 10 installed on the debarker arm 12 of FIG. 1, showing the working end 30 of the debarker arm 12 without its debarking tool 14 configured to remove bark from a log(not shown). FIG. 5 shows that the brake portion 24 of the removable brake 10 protects at least one side of the debarking tool 14, when removably installed in the debarking tool receiving portion 42 of the working end 30 of the debarker arm 12.

According to another embodiment, the removable brake 10 may be integrally formed as a single removable piece.

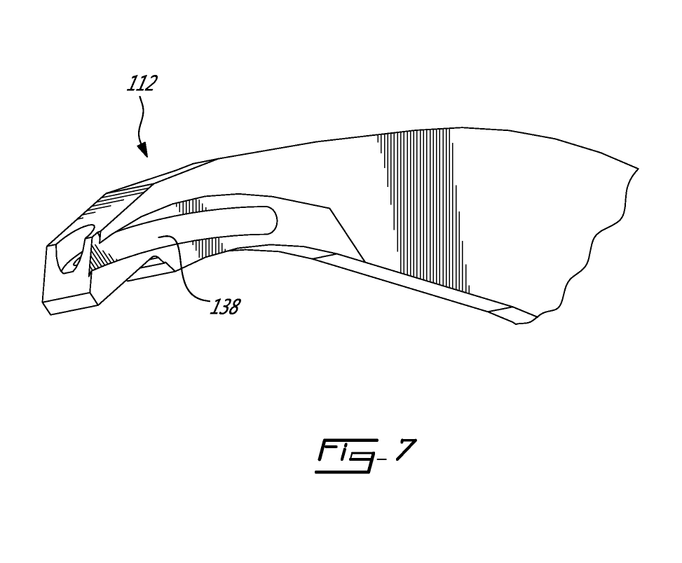

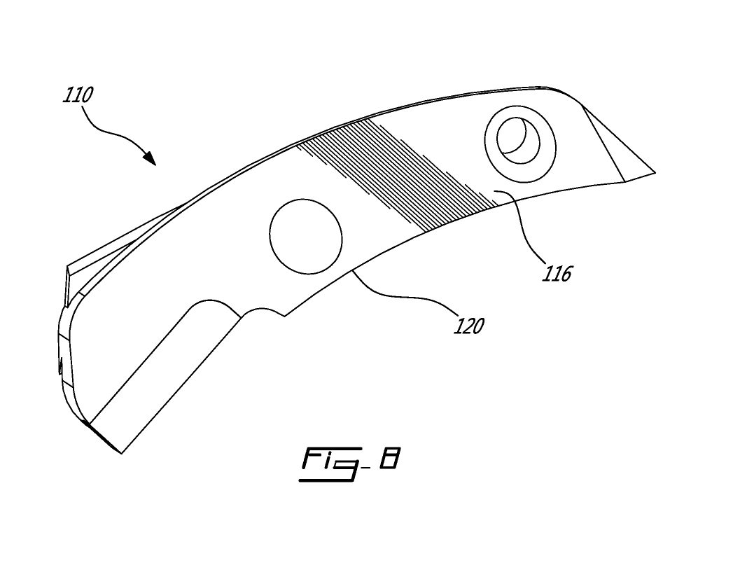

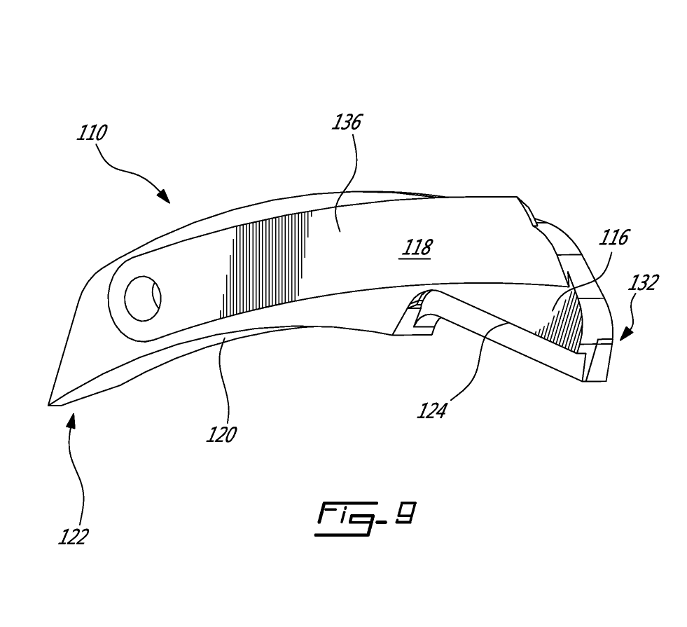

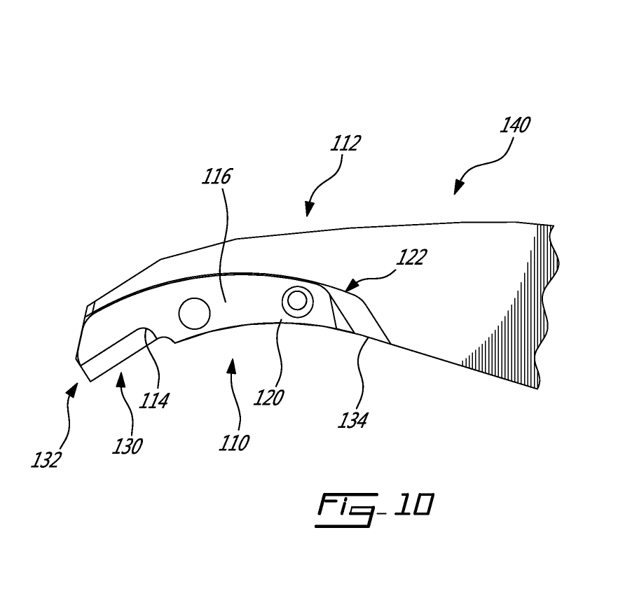

According to another embodiment and referring now to FIGS. 7, 8, 9 and 10, there is shown a removable brake 110 for a debarker arm 112. FIG. 10 shows that the debarker arm 112 has a working end 130 to which will be removably installed a debarking tool (not shown, also referred to as a cutting die or cutting tip) configured to remove bark from a log(not shown). The removable brake 110 includes a main body 116 and a mounting surface 118 (FIG. 9), where the mounting surface 118 is for removably mounting the removable brake 110 on the debarker arm 112. The removable brake 110 also includes a leading edge 120 starting at one end 122 of the main body 116 for causing the debarker arm 112 to move from an inner position toward an outer position when the leading edge 120 of the main body 116 engages an end face of the log(not shown) moving along a processing line toward the leading edge 120. The removable brake 110 also includes a brake portion 124 starting at another end 132 of the main body 116 for increasing the resistance offered against the debarker arm 112 while debarking the log.

According to an embodiment, the leading edge 120 of the main body 116 may correspond to a shape defined by an edge 134 of the debarker arm 112. According to an embodiment, the brake portion 124 forms a step/depression relative to the leading edge 120 and is thereby “lower” relative to leading edge 120.

According to another embodiment and still referring to FIGS. 7, 8, 9 and 10, the removable brake 110 may further include a fastener (not shown) for removably locking the main body 116 to the debarker arm 112. According to this embodiment, the main body 116 may further include a mating connector 136 for removably engaging with a corresponding mating connector 138 (see FIGS. 7 and 9) of the debarker arm 112. For example, the mating connector 136 of the main body may slide in the corresponding mating connector 138 for engaging with the debarker arm 112. In the example shown in FIGS. 7 and 9, the mating connector 136 is a protruding portion while the corresponding mating connector 138 is a recess portion. The mating connector 136 and the corresponding mating connector 138 may be in a sliding dovetail arrangement and/or any other suitable connector arrangement for removably engaging the removable brake 110 to the debarker arm 112 by sliding the mating connector 136 in/on the corresponding mating connector 138.

According to another embodiment and still referring to FIGS. 7 to 10, there is shown a debarker arm apparatus 140 (FIG. 10). The debarker arm apparatus 140 includes a debarker arm 112 which has a working end 130 to which is removably installed a debarking tool 114 and configured to remove bark from a log. The debarker arm apparatus 140 also includes a removable brake 110 removably mounted to the debarker arm 112. As described above, the removable brake 110 removably mounted on the debarker arm 112 includes a main body 116 and a mounting surface 118 on the main body 116 for removably mounting the removable brake 110 near the working end 130 of the debarker arm 112. The removable brake 110 also includes a leading edge 120 on one end 122 of the main body 116 for causing the debarker arm 112 to move from an inner position toward an outer position when the leading edge 120 of the main body 116 engages an end face of the log(not shown) moving along a processing line toward the leading edge 120. The debarker arm apparatus 140 further includes a brake portion 124 on starting at another end 132 of the main body 116 for increasing the resistance offered against the debarker arm 112 while debarking the log.

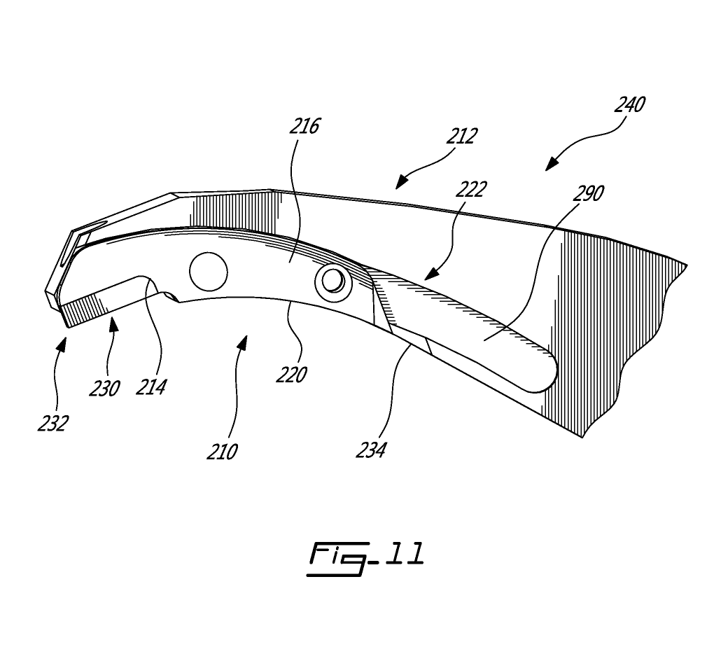

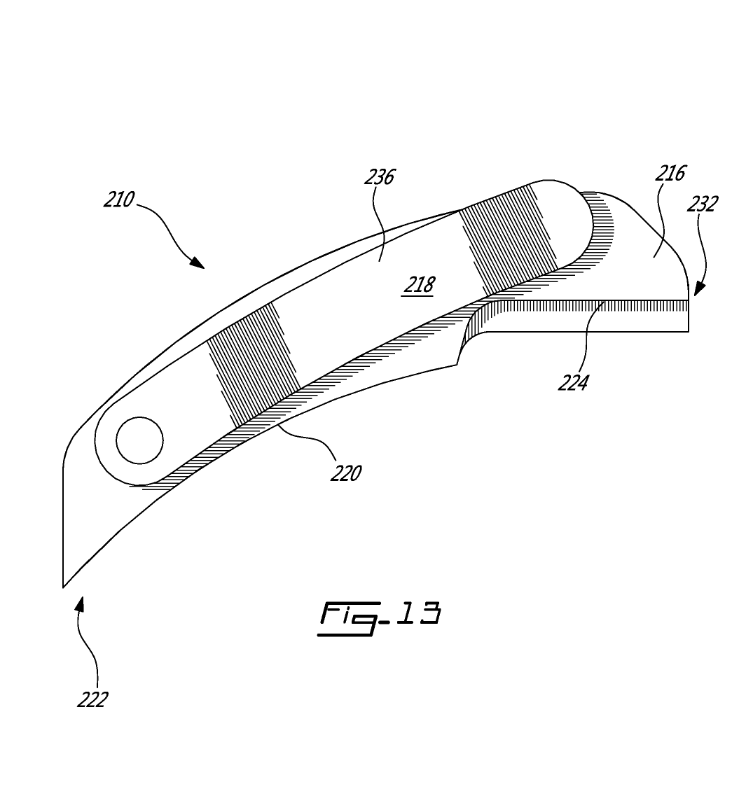

According to another embodiment and referring now to FIGS. 11, 12 and 13, there is shown a removable brake 210 for a debarker arm 212. FIG. 11 shows that the debarker arm 212 has a working end 230 to which will be removably installed a debarking tool (not shown, also referred to as a cutting die or cutting tip) configured to remove bark from a log(not shown). The removable brake 210 includes a main body 216 and a mounting surface 218 (FIG. 13), where the mounting surface 218 is for removably mounting the removable brake 210 on the debarker arm 212. The removable brake 210 also includes a leading edge 220 starting at one end 222 of the main body 216 for causing the debarker arm 212 to move from an inner position toward an outer position when the leading edge 220 of the main body 216 engages an end face of the log(not shown) moving along a processing line toward the leading edge 220. The removable brake 210 also includes a brake portion 224 starting at another end 232 of the main body 216 for increasing the resistance offered against the debarker arm 212 while debarking the log.

According to another embodiment, the leading edge 220 of the main body 216 may correspond to a shape defined by an edge 234 of the debarker arm 212. According to an embodiment, the brake portion 224 forms a step/depression relative to the leading edge 220 and is thereby “lower” relative to leading edge 220.

According to an embodiment, the removable brake 210 comprises an opening (not numbered) for receiving a fastener (not shown). The opening/fastener combination (i.e., a locking device) is used to lock the removable brake 210 in place once it is installed on the debarker arm 212. The fastener is used for exercising a pressure against the debarker arm thereby locking the removable brake in place.

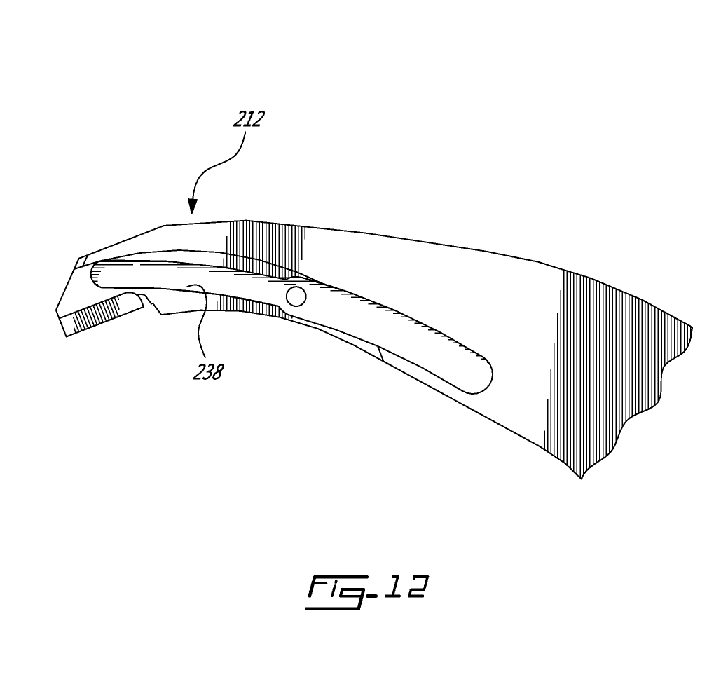

According to another embodiment and still referring to FIGS. 11, 12 and 13, the removable brake 210 may further include a fastener (not shown) for removably locking the main body 216 to the debarker arm 212. According to this embodiment, the main body 216 may further include a mating connector 236 for removably engaging with a corresponding mating connector 238 (see FIGS. 12 and 13) of the debarker arm 212. For example, the mating connector 236 of the main body may slide in the corresponding mating connector 238 (from a right to left translational motion according to FIG. 12) for engaging with the debarker arm 212. In the example shown in FIGS. 12 and 13, the mating connector 236 is a protruding portion while the corresponding mating connector 238 is a recess portion. The mating connector 236 and/or the corresponding mating connector 238 may be in a sliding dovetail arrangement and/or any other suitable connector arrangement for removably engaging the removable brake 210 to the debarker arm 212 by sliding the mating connector 236 in/on the corresponding mating connector 238. According to this embodiment, it is to be noted that the profile of the mating connector 238 has a T-shaped profile where the top of the “T” comprises lips which are made to slide within a corresponding channel (T-shaped of the mating connector 238. The mating connector 238 is therefore place within portion 290 the corresponding mating connector 238 and slid toward the working end of the debarker arm. Then, a fastener (not shown) is inserted in the opening (not numbered) for exercising a pressure against the debarker arm thereby locking the removable brake in place. When the removable brake 210 is removably installed within the corresponding mating connector 238 of the debarker arm 212, a portion 290 of the corresponding mating connector 238 is therefore left “empty”.

According to another embodiment and still referring to FIGS. 11 to 13, there is shown a debarker arm apparatus 240 (FIG. 11). The debarker arm apparatus 240 includes a debarker arm 212 which has a working end 230 to which is removably installed a debarking tool 214 and configured to remove bark from a log. The debarker arm apparatus 240 also includes a removable brake 210 removably mounted to the debarker arm 212. As described above, the removable brake 210 removably mounted on the debarker arm 212 includes a main body 216 and a mounting surface 218 on the main body 216 for removably mounting the removable brake 210 near the working end 230 of the debarker arm 212. The removable brake 210 also includes a leading edge 220 on one end 222 of the main body 216 for causing the debarker arm 212 to move from an inner position toward an outer position when the leading edge 220 of the main body 216 engages an end face of the log(not shown) moving along a processing line toward the leading edge 220. The debarker arm apparatus 240 further includes a brake portion 224 on starting at another end 232 of the main body 216 for increasing the resistance offered against the debarker arm 212 while debarking the log.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A removable brake for a debarker arm having a working end to which is removably installed a debarking tool configured to remove bark from a log, the removable brake comprising:
a main body;
a mounting surface on the main body for removably mounting the removable brake near the working end of the debarker arm; and
a brake portion on the main body for increasing a resistance offered against the debarker arm while debarking the log.

2. The removable brake of claim 1, wherein the mounting surface further includes a mating connector for removably engaging with a corresponding mating connector of the debarker arm.

3. The removable brake of claim 2, wherein the mating connector and the corresponding connector form a dovetail sliding arrangement.

4. The removable brake of claim 3, further comprising a locking device to lock the removable brake in place once it is installed on the debarker arm.

5. The removable brake of claim 4, wherein the locking device comprises a fastener and the main body comprises an opening for receiving the fastener, the fastener for exercising a pressure against the debarker arm thereby locking the removable brake in place.

6. The removable brake of claim 2, further comprising a fastener for removably mounting the removable brake to the debarker arm.

7. The removable brake of claim 6, wherein the main body comprises an opening for receiving the fastener.

8. The removable brake of claim 6, wherein the fastener comprises a plurality of fasteners for removably mounting the removable brake to the debarker arm.

9. The removable brake of claim 8, wherein the main body comprises a plurality of openings for correspondingly receiving the plurality of fasteners.

10. The removable brake of claim 1, further comprising a leading edge extending from the main body for causing the debarker arm to move from an inner position toward an outer position when the leading edge of the main body engages an end face of the log moving along a processing line toward the leading edge.

11. The removable brake of claim 10, wherein the leading edge of the main body corresponds to a shape defined by an edge of the debarker arm.

12. The removable brake of claim 10, wherein the brake portion is lower than leading edge thereby forming a step between the brake portion and the leading edge.

13. The removable brake of claim 1, wherein the removable brake is integrally formed.

14. A debarker arm apparatus comprising:
a debarker arm having a working end to which is removably installed a debarking tool configured to remove bark from a log;
a removable brake removably mounted to the debarker arm, the removable brake comprising:
a main body;
a mounting surface on the main body for removably mounting the removable brake near the working end of the debarker arm; and
a brake portion on the main body for increasing a resistance offered against the debarker arm while debarking the log.

15. The debarker arm apparatus of claim 14, wherein the main body further includes a mating connector and the debarker arm comprises a corresponding mating connector, the mating connector for removably engaging with the corresponding mating connector.

16. The debarker arm of claim 15, wherein the mating connector and the corresponding connector form a dovetail sliding arrangement.

17. The debarker arm of claim 16, further comprising a locking device to lock the removable brake in place once it is installed on the debarker arm.

18. The debarker arm of claim 17, wherein the locking device comprises a fastener and the main body comprises an opening for receiving the fastener, the fastener for exercising a pressure against the debarker arm thereby locking the removable brake in place.
